(19) United States
(12) Patent Application Publication
(10) Pub. No.: US 2016/0089845 A1
(43) Pub. Date: Mar. 31, 2016

(54) COMPACTOR SYSTEM AND METHOD

(71) Applicant: John C. Zimmer, Lafayette, LA (US)

(72) Inventor: John C. Zimmer, Lafayette, LA (US)

(21) Appl. No.: 14/496,613

(22) Filed: Sep. 25, 2014

(51) Int. Cl. B30B 9/30

(52) U.S. Cl. CPC B30B 9/3042; B30B 9/3075

(57) ABSTRACT

A compactor system for use on board marine vessels and offshore installation. The compactor has a cart with bottom and side members capable of withstanding a compaction force. The upper rim of the cart has a lip. The system has a compaction unit formed of a movable upper frame with a shoulder and a lower fixed frame. During waste compaction, the moveable upper frame moves in an upward direction to a point where the shoulder engages the cart's lip to establish a force-distribution loop among the upper frame and the side and bottom members of the cart. The cart's wheels are not subjected to the compaction force.

### CROSS-REFERENCE TO RELATED APPLICATIONS

This application claims the benefit of and priority to U.S. Provisional Application No. 61/882,952, filed Sep. 26, 2013, which is incorporated herein by reference.

### FIELD OF THE INVENTION

The present invention relates to a compactor system and method, and more particularly, to a waste compactor system and method for use on marine vessels such as ships and offshore installations.

### BACKGROUND OF THE INVENTION

Environmental concerns for the world's navigable waterways has led to regulations governing waste handling and disposal on marine vessels such as ships and offshore installations. The regulations have changed substantially over the past few years and continue to change to provide stricter rules for waste disposal for vessels at sea. International regulations include ISO 14001, IMO Marpol 73/78 Annex V and others. In the United States, the regulations include the MPRSA Marine Protection Research and Sanctuaries Act, 30 CFR Part 250 (Marpol) and others. With limited exceptions, most waste generated on marine vessels at sea is prohibited from being discharged overboard. Prohibited waste includes: plastic items such as synthetic ropes, synthetic fishing nets, plastic garbage bags and incinerator ashes from plastic products; certain food wastes; domestic waste such as drinking bottles, papers, cardboard, etc.; cooking oil; operational wastes; certain cargo residues; and fishing gear. Marine waste handling systems have been developed to contain on board waste for later disposal at land-based waste disposal or recycling facilities. The system may include a compactor that compacts different types of consumer waste or recyclable materials, including cardboard, food, paper, plastic, tin and metal cans, and the like.

Compactors specially designed to handle recyclable materials have been developed. For example, U.S. Pat. No. 5,129,318 to Zimmer discloses a compactor system with multiple carts positioned on a manually rotatable platform for rotation about a central axis to a point where the cart's contents are compacted by a hydraulic ram. Each cart may contain a different type of recyclable material such as plastic, aluminum, tin, paper, etc. The compactor is configured for use within a confined area, as for example, on an oil or production rig.

Delitek AS manufactures and sells waste compactors for used on board ships and other marine vessels. Delitek's compactors include Model Nos. DT-200MC, DT-500MC, DT-1500MC, and DT-2000MC. The Delitek compactors include a compacting unit and one or more wheeled carts containing the waste or recyclable material for compaction. Bothe the compacting unit and the cart are made of stainless steel to weather the onboard conditions at sea. During compaction, the ram mechanism may create compaction forces between 9 and 15 tons depending on the model size. Due to the configuration of the compactors, the compaction forces are directed and distributed primarily upon the bottom plate of the wheeled container (and the wheels) and then to the bottom member of the compacting unit upon which the wheeled container sits during the compacting process. The amount and distribution of the compaction forces requires that the compacting unit have bottom and side members capable of withstanding the compaction forces. The steel forming the compacting unit's bottom and side members contribute to an increase in the manufacturing costs associated with the compactors.

Because in the Delitek system, the compacting unit has a bottom member, the upper surface of which is elevated off the floor structure, ramps are provided for the loading and unloading of the carts. This design is problematic because the weight of the carts makes their manipulation and transportation into and out of the compacting unit vis-a-vis the ramp(s) difficult particularly given the swaying-action (pitch and roll) of the marine vessel. Because of their weight and instability on the ramps, the containers are subject to unintended movement and downward rolls off the ramp(s) that may cause injury to equipment and personnel.

Standard compactors distribute the compacting forces in a loop arrangement about the frame structure of the compacting unit. FIG. 1 depicts such a loop arrangement. The loop is formed by a top member 110 and a bottom member 112 interconnected by two side members 114, with a compaction cylinder 116 pushing a ram 118 to the opposite end of the box. In vertical compactors, the top member 110, bottom member 112, and side members 114 are connected in a fixed arrangement. The cylinder 116 is held by the top member 110. The cylinder 116 pushes the ram 118 into a cart 120, which is rolled out from under the ram 118 while still attached to the frame allowing the cart 120 to be loaded with more waste. The cart 120 may hold a bag to accommodate removal of the waste. The force of the ram 118 pushing downward is absorbed by wheels 122 affixed to the bottom 124 of the cart 120. Some conventional compactor systems include a mechanism for directing the downward force of the ram 118 to the bottom member of the frame. For example, a spring/pad assembly 126 may interconnect the bottom 124 of the cart 120 to the bottom member 112 of the compacting unit to lessen the impact on the cart's wheels 122. In this manner, the fixed bottom member 112 must absorb all of the force of cylinder 116.

U.S. Pat. No. 5,746,121 (the '121 patent), which is incorporated herein by reference and schematically depicted in FIG. 2, describes a compactor system in which the top member 10 is separable from the side members 114 to permit its selective horizontal displacement. The top member 110 may be rolled out of alignment with the cart 120 so that waste can be added to the cart 120 or compressed waste removed therefrom. The top member 110 may be rolled back into alignment with the cart 120 to perform compaction operations. The cart 120 is fixed within the compacting unit on bottom member 112 and is not transportable. During waste compaction, the top member 110 is vertically lifted as the ram 118 of the compactor cylinder 116 contacts the waste material in the container 120. When the top member 110 is raised a sufficient distance, it contacts or engages an upper portion of the side members 114 at top braces 128 to reestablish a standard loop whereby the compaction force is transferred through the side members 114 and into the bottom member 112 of the frame.

Despite the advancements made in waste compaction, the need still exists for a compactor system for use in the marine environment that is compact and sturdy, but also of reduced weight for ease of manufacture and of mobility on board a marine vessel. These needs, and others, are met by the compactor system and method of the present invention.

### SUMMARY OF THE INVENTION

It is an object of the present invention to provide a compactor system for use on board marine vessels such as ships and offshore installations.

It is a further object of the present invention to provide a compactor system that is cost-effective to manufacture.

It is a further object of the present invention to provide a compactor system with a reduced overall weight.

It is a further object of the present invention to provide a reduced-weight compacting unit.

It is a further object of the present invention to provide a compacting unit without a bottom member so that the cart rests on the floor when placed in operational position within the compacting unit.

It is a further object of the present invention to provide a compactor system in which the cart has a bottom member capable of withstanding the compaction force and which takes the place of the fixed bottom member of conventional compacting units.

It is a further object of the present invention to provide a compactor system capable of establishing a compaction force-distribution loop among the upper frame portion of the compacting unit and the side and bottom members of the cart.

It is a further object of the present invention to provide a compactor system in which the wheels on the underside of the cart are not subjected to the compaction force.

It is a further object of the present invention to provide a safer compactor system that eliminates the need for loading/unloading ramps.

It is a further object of the present invention to provide a multiuse compactor system wherein either the compacting unit and/or the container may be transportable.

These and other objects and advantages are achieved by the present invention, which is described herein. The present invention includes a compactor system that has a cart for containing a waste or recyclable material. The cart may have a floor panel and a plurality of interconnected side members defining an interior for containment of the waste material. A fixed bottom member may be secured to the underside of the floor panel. The upper rim of the cart may include a lip member. The lip member, bottom member, and the plurality of side members may be constructed to withstand a compaction force. A transport means may be affixed to the underside of the floor panel. The transport means may enable the cart to be moved about a floor structure.

The compactor system may include a compacting unit having a frame assembly defining a cavity for placement of the cart upon the floor structure during compaction of the waste or recyclable material. The frame assembly may include a moveable upper frame portion connected by a connection means to a lower fixed frame portion. The moveable upper frame portion may include a shoulder to cooperate with the lip of the cart. The lower fixed frame portion may have a plurality of support legs positioned on the floor structure.

The compactor system may include a compacting assembly for compacting the waste or recyclable material in the cart. The compacting assembly may be operatively connected to the moveable upper frame portion. The compacting assembly may include a ram member and a piston assembly operatively affixed thereto that when activated produces a compaction force to compact the waste or recyclable material in the cart.

In the compactor system of the present invention, the moveable upper frame portion may move upward in response to the ram member encountering the waste or recyclable material resulting in the engagement of the shoulder of the moveable upper frame portion with the lip member of the cart to thereby establish a compaction force-distribution loop among the moveable upper frame portion and the plurality of side members and bottom member of the cart.

The side and bottom members of the cart are subjected to and are capable of withstanding the compaction force. The engagement of the shoulder of the moveable upper frame portion with the lip member of the cart prevents distribution of the compaction force upon the transport means of the cart.

In another embodiment of the compactor system, the moveable upper frame portion may include a top member and a plurality of perpendicularly extending side arms affixed thereto.

In another embodiment of the compactor system, the connection means may include a pin extending from an upper end of each of the plurality of support legs and a vertical slot in each of the plurality of perpendicularly extending side arms of the moveable upper frame portion through which one of pins is operatively positioned.

In another embodiment of the compactor system, the plurality of support legs of the fixed lower frame portion comprises four support legs and the plurality of perpendicularly extending side arms of upper frame portion comprises four side arms.

In another embodiment of the compactor system, the moveable upper frame portion may have two shoulders and the upper rim of the cart may have two lip members. Each shoulder may extend between two of the side arms. Each shoulder may cooperate with one of the lip members.

In another embodiment of the compactor system, one or more brace members interconnect the top member to each of the shoulders.

In another embodiment of the compactor system, the plurality of support legs are detachably affixed to the floor structure.

In another embodiment of the compactor system, the transport means includes a wheel assembly. The wheel assembly includes two pairs of wheels.

In another embodiment of the compactor system, the cart is without the transport means and may be detachably affixed to the floor structure. The plurality of support legs may each include transporting means enabling the compacting unit to move about the floor structure for placement over the cart for compaction of the waste material and removal therefrom after compaction. The transporting means may be a wheel or roller.

In another embodiment of the compactor system, the cart may include a lock mechanism for securing the cart within the cavity of the compacting unit during compaction of the waste or recyclable material.

In another embodiment of the compactor system, one of the plurality of side members of the cart may comprise a door for gaining access to the interior of the cart for placement or removal of waste or recyclable material therefrom.

In another embodiment of the compactor system, the compacting unit and cart are each made of metal. The metal may be stainless steel.

In another embodiment of the compactor system, the compacting assembly may include a guide for stabilizing the ram member. The guide may have an upper end operatively connected to the moveable upper frame portion and a lower end operatively connected to the ram member. The guide may be substantially parallel to the piston assembly.

In another embodiment of the compactor system, the piston assembly may be actuated by electronic, mechanical, pneumatic or hydraulic means.

The present invention is also directed to a method of compacting a waste material. The method may comprise the step of providing a compactor system as aforementioned. The method may include placing the waste or recyclable material to be compacted into the interior of the cart. The method may include causing the cart to be operationally positioned within the compacting unit. The method may include activating the compacting assembly to compact the waste or recyclable material in the cart by extending the ram member. The method may include moving the moveable upper frame portion upward to a compacting position in response to the ram member encountering the waste or recyclable material. The method may include engaging the lip member of the cart with the shoulder of the moveable upper frame portion to establish a compaction force-distribution loop among the moveable upper frame portion and the plurality of side members and bottom member of the cart to prevent the transport means of the cart from being subjected to the compaction force.

In another embodiment of the method, the steps may include retracting the ram member, moving the moveable upper frame portion downward to a non-compacting position, and removing the cart from the compacting unit.

In another embodiment of the method, for the steps of causing the cart to be operationally positioned within the compacting unit and of removing the cart from the compacting unit, the moveable upper frame assembly is in a non-compacting position whereby a gap exists between the shoulder of the moveable upper frame portion and the lip member of the cart.

In another embodiment of the method, the steps may include removing the compacted waste or recyclable material from the interior of the cart, and storing the compacted waste or recyclable material for later disposal or recycling.

In another embodiment of the method, the transport means of the cart may include a wheel assembly, the plurality of support legs may be detachable affixed to the floor structure, and the cart may be operationally positioned within the compacting unit by moving the cart into the cavity of the frame assembly.

In another embodiment of the method, the cart is without the transport means and may be detachable affixed to the floor structure, the plurality of support legs may each include a transporting means, and the cart may be operationally positioned within the compacting unit by moving the compacting unit over the cart so that the cart is situated within the cavity of the frame assembly up on the floor structure. The transporting means may be a wheel or roller.

In another embodiment of the method, the steps may include providing a second cart, placing a second type of waste or recyclable material to be compacted into the interior of the second cart, causing the second cart to be operationally positioned within the compacting unit, activating the compacting assembly to compact the waste or recyclable material in the second cart by extending the ram member, moving the moveable upper frame portion upward to a compacting position in response to the ram member encountering the waste or recyclable material, engaging the lip member of the second cart with the shoulder of the moveable upper frame portion to establish a compaction force-distribution loop among the moveable upper frame portion and the plurality of side members and bottom member of the second cart and to prevent the transport means of the second cart from being subjected to the compaction force, retracting the ram member, moving the moveable upper frame portion downward to a non-compacting position, and removing the second cart from the compacting unit.

In another embodiment of the method, the steps may include repeating all of the steps recited in the previous paragraph with a third cart containing a third type of waste or recyclable material.

One of the novel features of the present invention is the establishment of the compaction force-distribution loop among the moveable upper frame portion and the plurality of side members and bottom member of the cart. The compaction force-distribution loop is accomplished by providing a frame assembly that is divided into two portions; a moveable upper frame portion and a lower fixed frame portion. Because the compacting assembly is operatively connected to the moveable upper frame portion of the frame assembly, the moveable upper frame portion will move upwards when the ram member of the compacting assembly encounters waste material in the interior of the container during compaction operations. When the moveable upper frame portion moves a required distance, the shoulder of the moveable upper frame portion engages the lip extending on the upper rim of the cart. This engagement establishes the compaction force-distribution loop and further serves to prevent the transport means affixed to the bottom member of the cart from being subjected to the compaction force, which is transferred to the moveable upper frame portion through the engagement of the lip member with the shoulder.

Because of the unique compaction force-distribution loop arrangement of the compactor system of the present invention, the compacting unit or frame assembly does not require bottom and side members to absorb the compaction force. The bottom and side members are now present on the cart, which is included within the compaction force-distribution loop, together with the moveable upper frame portion of the compacting unit. The elimination of the bottom and side members from the compacting unit achieves advantages in manufacturing as the compactor system is made more cost-effective. An estimated 75% less stainless steel is required to construct the compactor system of the present invention. The elimination also provides for a safer compactor system as the need for loading/unloading ramps to gain access to the upper surface of the bottom member, as in conventional systems, is not required. In the compactor system of the present invention, the floor structure serves as the support for the cart when place into the compacting position within the compactor unit.

The compactor system of the present invention may also be used in recycling operations on board marine vessels and offshore installations. The system may include multiple carts for use within the compacting unit. Different types of recyclable material such as plastic, aluminum, tin, paper, and the like may be separately placed within individual carts for collection purposes. Each cart may then be placed within the compacting unit for compaction of the recyclable material within the cart. The cart containing the compacted recyclable material may then be removed from the compacting unit for storage, and another cart containing a different type of recyclable material placed within the compacting unit for compacting the recyclable material. In this fashion, recyclable material may be compacted and thereafter stored aboard the marine vessel or offshore installation until such time that the stored material can be sent to a recycling facility.

### BRIEF DESCRIPTION OF THE DRAWINGS

FIG. 1 is a schematic of a conventional compactor.

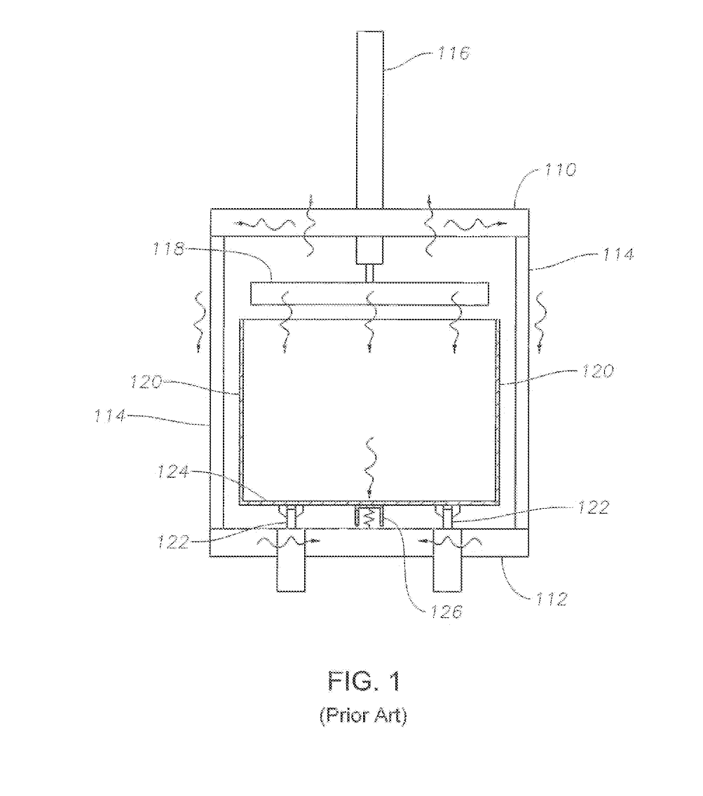

FIG. 2 Is a schematic of another conventional compactor.

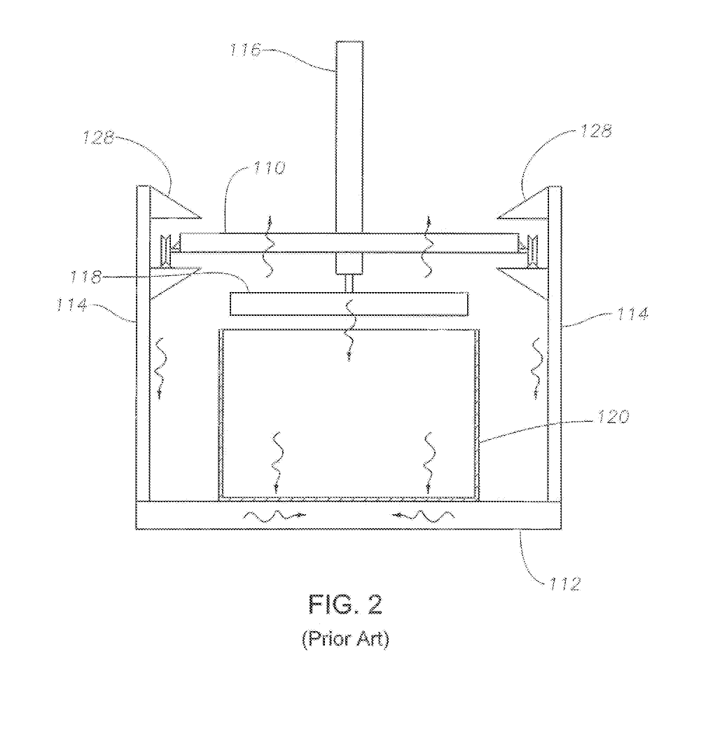

FIG. 3 is a front perspective view of the frame assembly of the compacting unit.

FIG. 4 is an exploded front perspective view of the frame assembly.

FIG. 5 is a front perspective view of the cart.

FIG. 6 is a rear perspective view of the compactor system.

FIG. 7 is a rear perspective view of the compactor system with the cart locked within the compacting unit.

FIG. 8 is a schematic view of the compactor system with the upper frame portion in the non-compacting position.

FIG. 9 is a top view of the compactor system.

FIG. 10 is a schematic view of the compactor system with the upper frame portion in the compacting position.

### DETAILED DESCRIPTION OF THE PREFERRED EMBODIMENTS

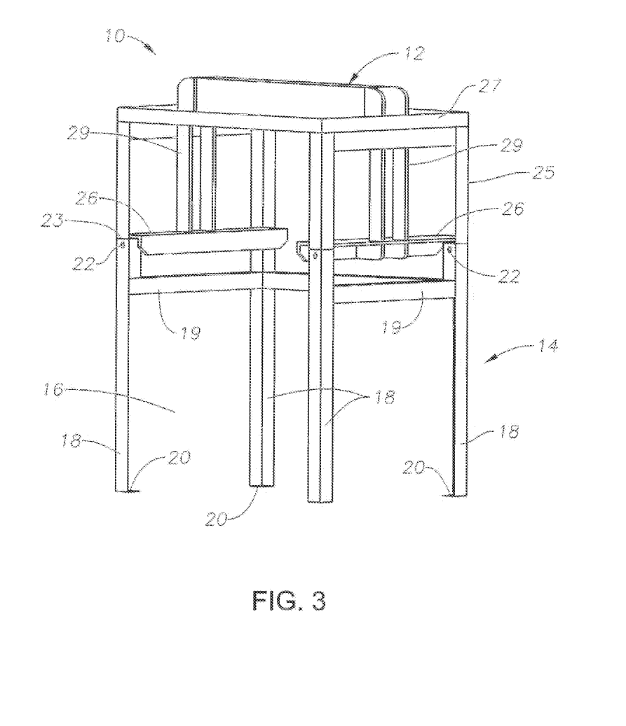

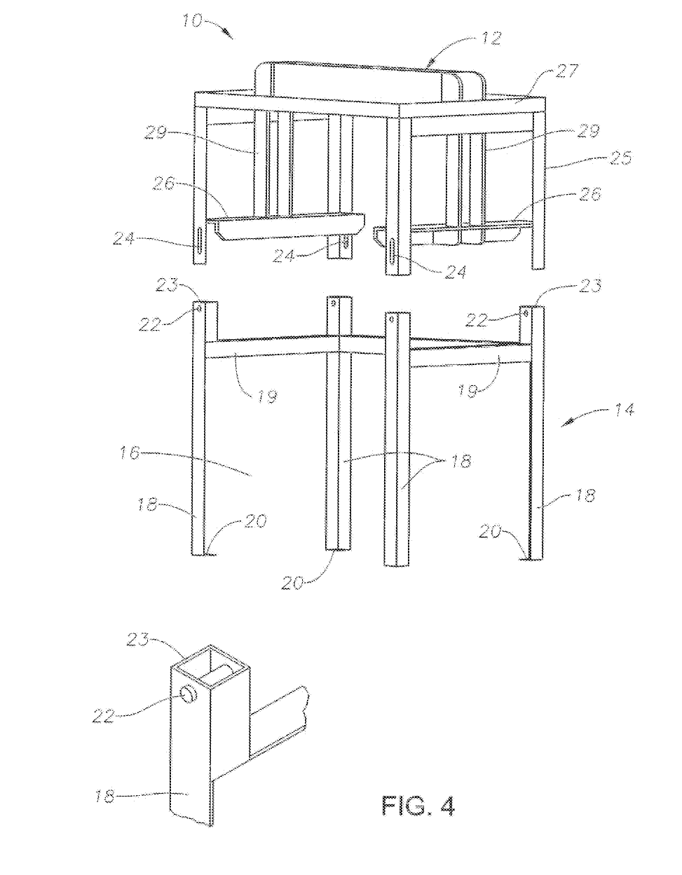

A compactor system may include a compacting unit having frame assembly 10 as shown in FIGS. 3 and 4. Frame assembly 10 may include moveable upper frame portion 12 and lower fixed frame portion 14. Frame assembly 10 may also include cavity 16. Lower fixed frame portion 14 may include support legs 18 interconnected in spaced-relation by braces 19. Support legs 18 may be configured in a square, rectangular, or other arrangement to form cavity 16. Lower fixed frame portion 14 supports moveable upper frame portion 12. Foot members 20 may be operatively connected to a lower end of each of support legs 18. Foot members 20 may be used to secure frame assembly 10 to a floor structure to stabilize the compactor system when the ship is in motion. The floor structure may be the floor of a marine vessel such as ship or offshore installation.

An upper end of each support leg 18 of lower frame portion 14 may include pin 22 and support surface 23. Upper frame portion 12 may include vertical slots 24. In one embodiment, slots 24 may be disposed through a lower end of each side arm 25 of upper frame portion 12. Each pin 22 may be disposed through one of vertical slots 24 such that upper frame portion 12 is moveably connected (e.g., in sliding arrangement) to lower frame portion 14 allowing vertical movement of upper frame portion 12 relative to lower frame portion 14. Side arms 25 are affixed to top member 27 and extend perpendicular thereto. Upper frame portion 12 may also include shoulders 26. Brace members 29 interconnect top member 27 to shoulders 26.

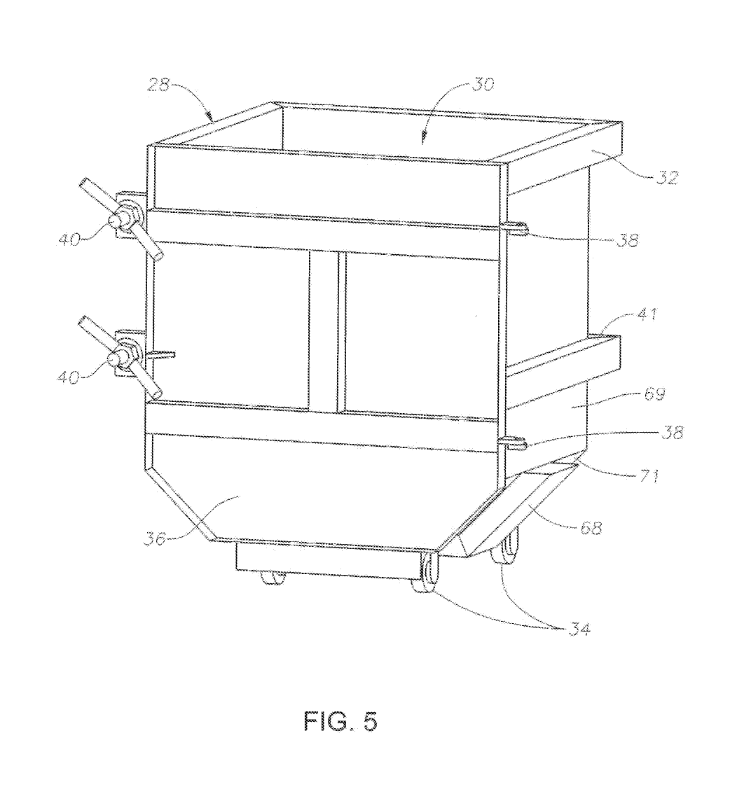

Cavity 16 of frame assembly 10 may be dimensioned to receive a cart, such as cart 28 illustrated in FIG. 5. Cart 28 may include interior space 30 for holding material. Cart 28 may have floor panel 71 and interconnected side members 69. Bottom member 68 is affixed to the underside of floor 71. Bottom member 68 and side members 69 are constructed to withstand the compaction force during compaction operations. The material held in interior space 30 may be any material capable of being compacted, such as waste. Cart 28 may also include lip member 32 about the upper rim of cart 28. Lip member 32 may also be constructed to withstand the compaction force. Cart 28 may include wheel assembly 34. Wheel assembly 34 may be a pair of wheels or two pairs of wheels. Wheel assembly 34 may be positioned on the underside of floor panel 71. Cart 28 may further include door 36 connected to cart 28 with hinges 38. Securing mechanism 40 may be used to selectively lock door 36 in a closed position as shown. Securing mechanism 40 may be any type of securing mechanism, including a rotating mechanism as shown in FIG. 5. Cart 28 may include stop means 41 forming an external ridge around side member 69 to assist in the placement of cart 28 within cavity 16.

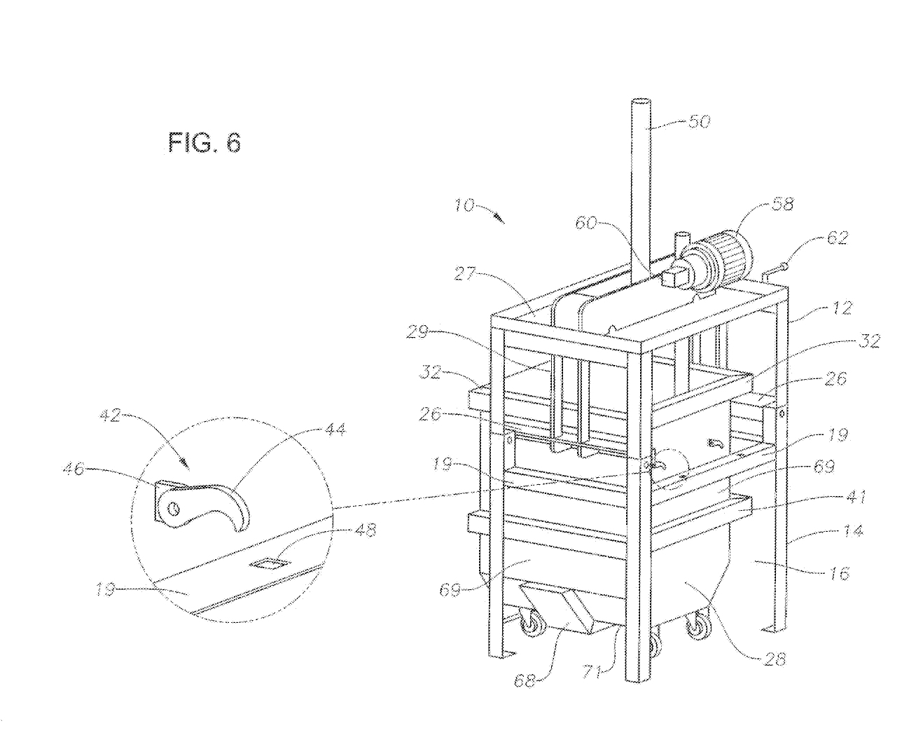

FIG. 6 shows a cart 28 within cavity 16 of frame assembly 10. Lip member 32 of cart 28 is disposed above shoulders 26 of upper frame position 12. Cart 28 may include a lock mechanism for securing cart 28 to frame assembly 10. The lock mechanism may include latch assembly 42 having latch 44 affixed to cart 28 through brace 46. Brace 19 may include aperture 48 dimensioned to receive latch 44. Brace 19 may include more than one aperture 48 to receive more than one latch 44 of cart 28. FIG. 6 shows cart 28 having two latches 44 and brace 19 having two apertures 48. It is to be understood that the compactor system may have any number of latches 44 and apertures 48.

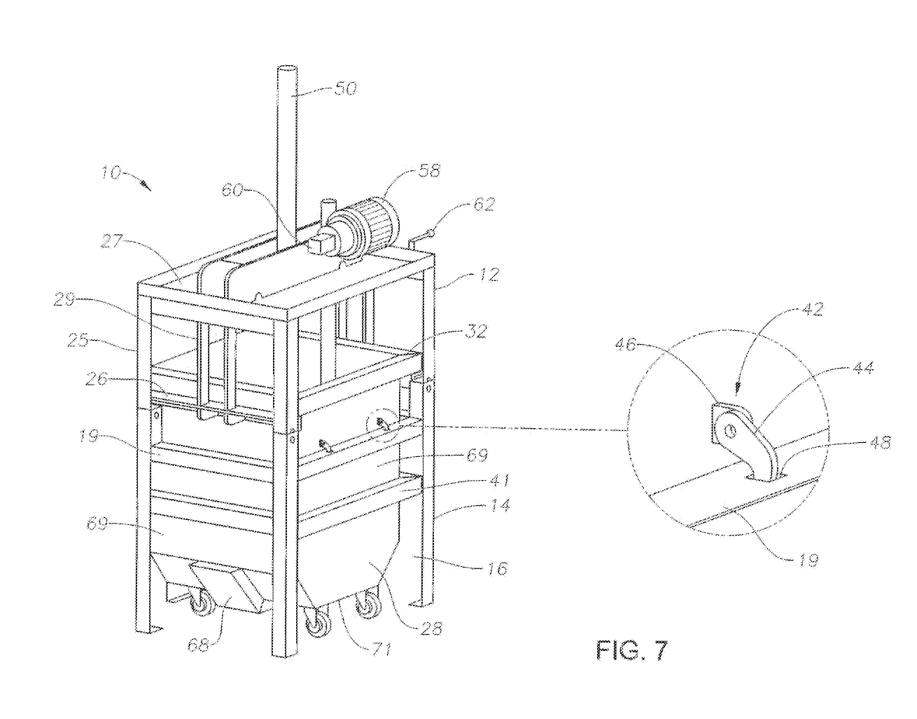

By placing an end of latch 44 through aperture 48, cart 28 may be secured to lower frame 14 as shown in FIG. 7.

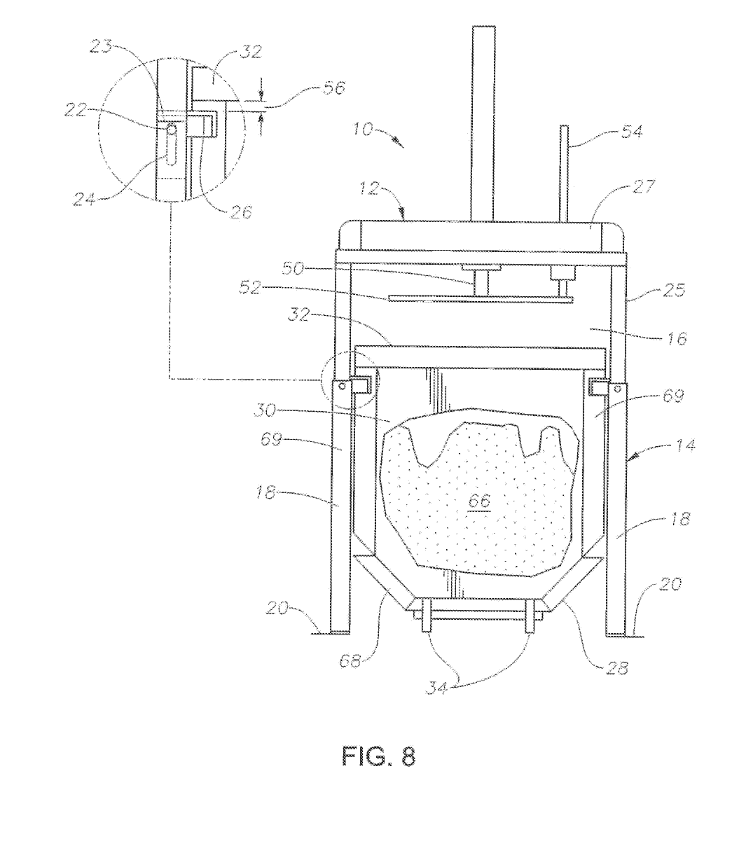

With reference to FIG. 8, the compactor system may also include piston assembly 50 (e.g. cylinder, road and piston) for controlling a vertical movement of ram member 52. An upper end of piston assembly 50 may be operatively attached to upper frame portion 12 (at top member 27) and a lower end of piston assembly 50 may be attached to ram member 52. Guide 54 may also be operatively connected to upper frame portion 12 (at top member 27) and ram member 52 for stabilizing ram member 52. FIG. 8 shows frame assembly 10 in a non-compacting (load position for loading cart 28) position in which shoulders 26 of upper frame portion 12 are supported by support surfaces 23 of lower frame 14. With frame assembly 10 in the non-compacting position and cart 28 positioned within cavity 16 of frame assembly 10, lip member 32 may be disposed a distance 56 above shoulders 26. Distance 56 permits cart 28 to be in an unobstructed position so that cart 28 may be moved into and out of cavity 16. In the load position, pin 22 of lower frame portion 14 may be disposed near an upper end of vertical slot 24 of upper frame portion 12.

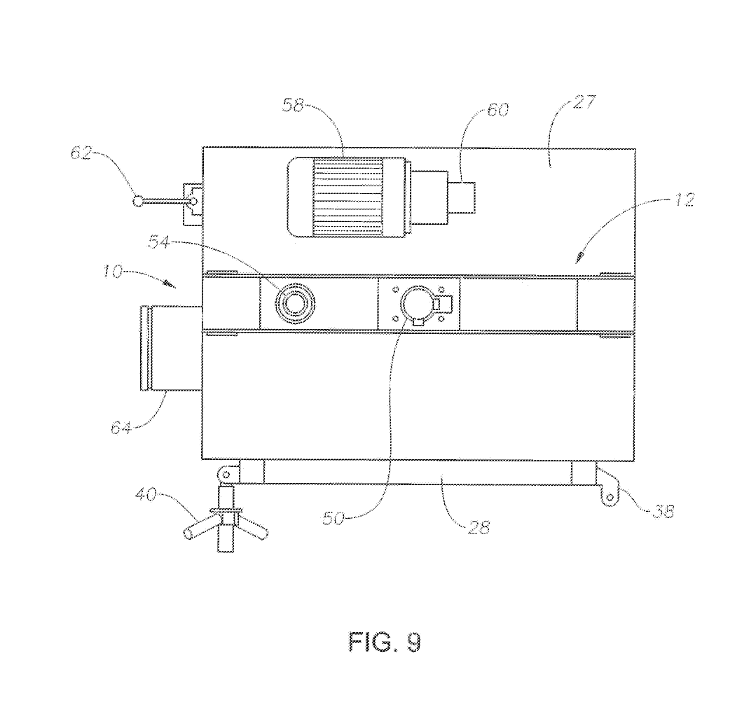

Referring to FIG. 9, the compactor system may further include electric motor 58, hydraulic pump 60, control valve 62, and starter 64 for controlling piston assembly 50. A user may activate starter 64 to activate electric motor 58 to operate hydraulic pump 60. Hydraulic pump 60 may send fluid through control valve 62 and to piston assembly 50. A user may adjust control valve 62 to extend or retract piston assembly 50 thereby vertically moving ram member 52.

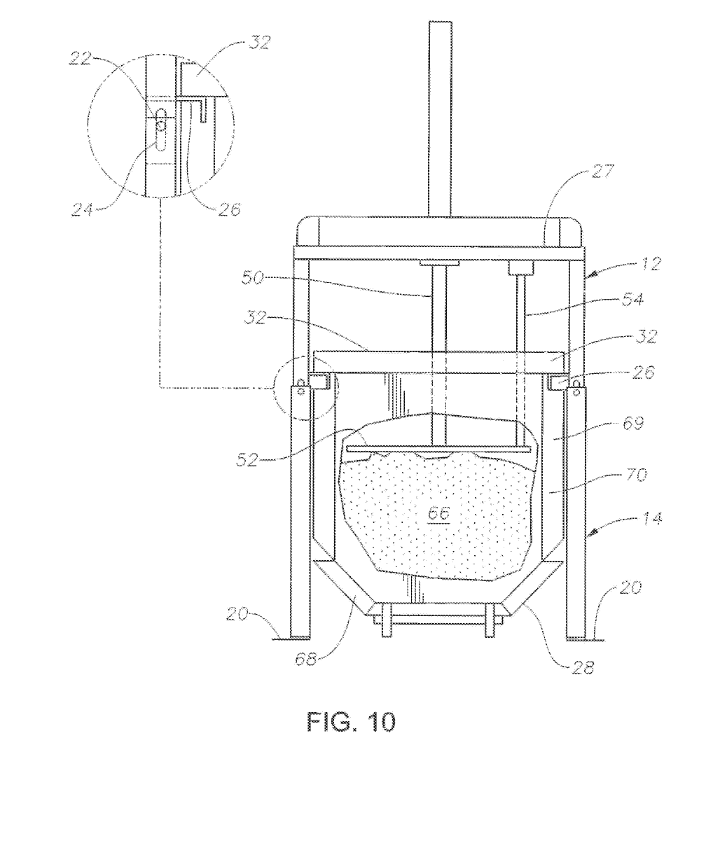

With reference now to FIGS. 8-10, the compactor system may be used to compact material 66 contained within interior space 30 of cart 28. Electric motor 58 and hydraulic pump 60 may be used to extend piston assembly 50 in order to lower ram member 52. When ram member 52 contacts material 66, further extension of piston assembly 50 may lift upper frame portion 12 to a raised position (shown in FIG. 10) in which shoulder 26 of upper frame portion 12 contacts lip member 32 of cart 28. Upper frame portion 12 is capable of moving to the raised position because of the connection of upper frame portion 12 to lower frame portion 14 through in 22 and vertical slot 24. As upper frame portion 12 is moved upward, vertical slot 24 is also moved upward relative to pin 22. In the raised position, pin 22 of lower frame position 14 may be disposed lower than the upper end of vertical slot 24 of upper frame portion 12 as shown in FIG. 10.

Further extension of piston assembly 50 with upper fame portion 12 in the raised position may apply a compaction force to material 66. While compacting material 66 in cart 28, the compaction force applied by ram member 52 is distributed or transferred from upper frame portion 12 to side member 69 and bottom member 68 of cart 28 by engagement of lip member 32 of cart 28 with shoulders 26 of upper frame portion 12. In particular, the compaction force is transferred from top member 27 to brace members 29 to shoulders 26 to lip member 32 to side members 69 and to bottom member 68. No compaction force is applied to wheels 34 and cart 28. No compaction force is applied through lower frame 14. The compaction force caused by operation of the compacting assembly may be from 9 to 15 tons.

After compaction is complete, piston assembly 50 may be retracted in order to raise ram member 52. As ram member 52 is lifted out of contact with material 66, upper frame portion 12 may be lowered into the non-compacting position (shown in FIG. 8) in which lip member 32 of cart 28 is disposed distance 56 above shoulders 26. This movement will occur when the force exerted by ram member 52 is less than the weight of upper frame portion 12. Upper frame portion 12 will stop moving once shoulders 26 of upper frame 12 are supported on support surfaces 23 of lower frame portion 14, and pin 24 of lower frame 14 is disposed through the upper end of vertical slot 24 of upper frame portion 12. Further retraction of piston assembly 50 may lift ram member 52 out of interior space 30 of cart 28. The lock mechanism may then be disengaged so that cart 28 may be removed from cavity 16 of frame assembly 10. Securing mechanism 40 may be disengaged so that door 36 of can 28 may be opened to remove the compacted material 66.

It is to be understood that a waste collection bag may be placed within interior space 30 of cart 28 to hold the waste material.

When cart 28 is not positioned within cavity 16 of frame assembly 10, it may be secured to a wall or any other structure having an aperture dimensioned to receive latch 44 of latch system 42. This feature may be useful for storage of cart 28 on a ship during movement.

The compaction system may be used with more than one cart. The compaction system may be used with a cart that is fixed to a floor by placing frame assembly 10 over the stationary cart. For example, transport means such as wheels may be placed under foot members 20 of lower frame portion 14 in order to facilitate the movement of frame assembly 10.

The compactor system may be constructed of metal. The metal may be stainless steel. It is to be understood that frame assembly 10 may be plated to form an enclosure or housing.

Because frame assembly 10 includes no bottom member below cavity 16, no ramp is required t roll cart 28 into cavity 16 of frame assembly 10. The absence of a ramp eliminate the safety hazards associated with rolling a cart up and down a ramp. Frame assembly 10 weighs less than conventional compactor systems because of the absence of a bottom member (about 75% of the stainless steel material is eliminated).

While preferred embodiments of the present invention have been described, it is to be understood that the embodiments are illustrative only and that the scope of the invention is to be defined solely by the appended claims when accorded a full range of equivalents, many variations and modifications naturally occurring to those skilled in the art from a review hereof.

What is claimed is:

1. A compactor system comprising:
a) a cart for containing a waste or recyclable material, the cart having a floor panel and a plurality of interconnected side members defining an interior for containment of the waste or recyclable material, a fixed bottom member secured to an underside of the floor panel, an upper rim of the cart including a lip member, wherein the lip member, the bottom member, and the plurality of side members are constructed to withstand a compaction force;
b) a transport means affixed to the underside of the floor panel, the transport means enabling the cart to be moved about a floor structure;
c) a compacting unit having a frame assembly defining a cavity for placement of the cart upon the floor structure during compaction of the waste or recyclable material, the frame assembly including a moveable upper frame portion connected by a connection means to a lower fixed frame portion, die moveable upper frame portion including a shoulder to cooperate with the lip of the cart, the lower fixed frame portion having a plurality of support legs positioned on the floor structure;
d) a compacting assembly for compacting the waste or recyclable material in the cart, the compacting assembly operatively connected to the moveable upper frame portion, the compacting assembly including a ram member and a piston assembly operatively affixed thereof that when activated produces the compaction force to compact the waste or recyclable material in the cart;
e) wherein during compaction of the waste or recyclable material, the moveable upper frame portion moves upward in response to the ram member encountering the waste or recyclable material resulting in an engagement of the shoulder of the moveable upper frame portion with the lip member of the cart thereby establishing a compaction force-distribution loop among the moveable upper frame portion and the plurality of side members and bottom member of the cart and preventing distribution of the compaction force upon the transport means of the cart.

2. The compactor system of claim 1, wherein the moveable upper frame portion includes a top member and a plurality of perpendicularly extending side arms affixed thereto.

3. The compactor system of claim 2, wherein the connection means includes a pin extending from an upper end of each of the plurality of support legs and a vertical slot in each of the plurality of perpendicularly extending side arms through which one of the pins is operatively positioned.

4. The compactor system of claim 3, wherein the plurality of support legs comprises four support legs and the plurality of perpendicularly extending side arms comprises four side arms.

5. The compactor system of claim 4, wherein the moveable upper frame portion includes two shoulders and the upper rim of the cart includes two lip members, each shoulder extending between two of the side arms, each shoulder to cooperate with one of the lip members.

6. The compactor system of claim 5, wherein a one or more brace members interconnect the top member to each of the shoulders.

7. The compactor system of claim 1, wherein the plurality of support legs are detachably affixed to the floor structure.

8. The compactor system of claim 7, wherein the transport means includes a wheel assembly.

9. The compactor of claim 8, wherein the wheel assembly includes two pairs of wheels.

10. The compactor system of claim 1, wherein the cart is without the transport means and is detachably affixed to the floor structure, and the plurality of support legs of the frame assembly each include transporting means enabling the compactor unit to move about the floor structure for placement over the cart for compaction of the waste material and removal therefrom after compaction.

11. The compactor system of claim 10, wherein the transporting means is a wheel or roller.

12. The compactor system of claim 1, wherein the cart includes a lock mechanism for securing the cart within the cavity of the compacting unit during compaction of the waste or recyclable material.

13. The compactor system of claim 1, wherein one of the plurality of side members comprises a door for gaining access to the interior of the cart for placement or removal of waste or recyclable material therefrom.

14. The compactor system of claim 1, wherein the compacting unit and cart are each made of metal.

15. The compactor system of claim 14, wherein the metal is stainless steel.

16. The compactor system of claim 1, wherein the compacting assembly includes a guide for stabilizing the ram member, the guide having an upper end operatively connected to the moveable upper frame portion and a lower end operatively connected to the ram member, the guide being substantially parallel to the piston assembly.

17. The compactor system of claim 1, wherein the piston assembly is actuated by electronic, mechanical, pneumatic or hydraulic means.

18. A method of compacting a waste material, comprising the steps of:
a) providing a compactor system comprising: a cart for containing a waste or recyclable material, the cart having a floor panel, and a plurality of interconnected side members defining an interior for containment of the waste or recyclable material, a fixed bottom member secured to an underside of the floor panel, an upper rim of the cart including a lip member, wherein the lip member, bottom member, and plurality of side members being constructed to withstand a compaction force; a transport means affixed to the underside of the floor panel, the transport means enabling the cart to be moved about a floor structure; a compacting unit having a frame assembly defining a cavity for placement of the cart during compaction of the waste or recyclable material, the frame assembly including a moveable upper frame portion connected by a connection means to a lower fixed frame portion, the moveable upper frame portion including a shoulder to cooperate with the lip of the cart, the lower fixed frame portion having a plurality of support legs positioned on the floor structure; a compacting assembly for compacting the waste or recyclable material in the cart, the compacting assembly operatively connected to the moveable upper frame portion, the compacting assembly including a ram member and a piston assembly operatively affixed thereto that when activated produces the compaction force to compact the waste or recyclable material in the cart;
b) placing the waste or recyclable material to be compacted into the interior of the cart;
c) causing the cart to be operationally positioned within the compacting unit;
d) activating the compacting assembly to compact the waste or recyclable material in the cart by extending the ram member;
e) moving the moveable upper frame portion upward to a compacting position in response to the ram member encountering the waste or recyclable material;
f) engaging the lip member of the cart with the shoulder of the moveable upper frame portion to establish a compaction force-distribution loop among the moveable upper frame portion and the plurality of side members and bottom member of the cart and to prevent the transport means of the cart from being subjected to the compaction force.

19. The method of claim 18, further comprising the steps of:
h) retracting the ram member;
i) moving the moveable upper frame portion downward to a non-compacting position;
j) removing the cart from the compacting unit.

20. The method of claim 18, wherein in steps (c) and (j), the moveable upper frame assembly is in a non-compacting position whereby a gap exists between the shoulder of the moveable upper frame portion and the lip member of the cart.

21. The method of claim 19, further comprising the steps of:
k) removing the compacted waste or recyclable material from the interior of the cart;
l) storing the compacted waste or recyclable material for later disposal or recycling.

22. The method of claim 18, wherein the transport means of the cart includes a wheel assembly, wherein the plurality of support legs are detachably affixed to the floor structure, and wherein in step (c) the cart is operationally positioned within the compacting unit by moving the cart into the cavity of the frame assembly.

23. The method of claim 18, wherein the cart is without the transport means and is detachably affixed to the floor structure, wherein the plurality of support legs of the frame assembly each includes a transporting means, and wherein in step (c), the cart is operationally positioned within the compacting unit by moving the compacting unit over the cart so that the cart is situated within the cavity of the frame assembly upon the floor structure.

24. The method of claim 23, where the transporting means comprises a wheel or roller.

25. The method of claim 18, further comprising the steps of:
k) providing a second cart;
l) placing a second type of waste or recyclable material to be compacted into the interior of the second cart;
m) causing the second cart to be operationally positioned within the compacting unit;
n) activating the compacting assembly to compact the waste or recyclable material in the second cart by extending the ram member;
o) moving the moveable upper frame portion upward to a compacting position in response to the ram member encountering the waste or recyclable material;
p) engaging the lip member of the second cart with the shoulder of the moveable upper frame portion to establish a compaction force-distribution loop among the moveable upper frame portion and the plurality of side members and bottom member of the second cart and to prevent the transport means of the second cart from being subjected to the compaction force;
q) retracting the ram member;
r) moving the moveable upper frame portion downward to a non-compacting position;
s) removing the second cart from the compacting unit.

26. The method of claim 25, further comprising the steps of repeating steps (a) through (s) with a third cart containing a third type of waste or recyclable material.
